(19) United States
(12) Patent Application Publication
(10) Pub. No.: US 2014/0019306 A1
(43) Pub. Date: Jan. 16, 2014

(54) Digital showroom management system and method

(71) Applicant: MARINE DEALER TECHNOLOGIES, INC., Jackson, MI (US)

(72) Inventors: Kris A. Thayer, Jackson, MI (US); Michael E. Thayer, Jackson, MI (US); Candace L. Thayer, Jackson, MI (US)

(73) Assignee: MARINE DEALER TECHNOLOGIES, INC., Jackson, MI (US)

(21) Appl. No.: 13/840,399

(22) Filed: Mar. 15, 2013

Related U.S. Application Data
(60) Provisional application No. 61/759,510, filed on Feb. 1, 2013.
(60) Provisional application No. 61/670,206, filed on Jul. 11, 2012.

(51) Int. Cl. G06Q 30/06

(52) U.S. Cl. CPC G06Q 30/0641
USPC 705/27.1

(57) ABSTRACT

A computer implemented digital showroom management system and method provides a software application and database system for entering data into for a plurality of product brands including competing brands and provides limited access to information about the brands to dealers based on their affiliation with certain brands. Dealers using the system and method enter pricing and margin information for products within each of the brands including pricing and margin information for brand/product options and features. System and method provide for creating reports and allows a salesperson to stay with the customer and utilize automated system for assisting in making sales.

### CROSS-REFERENCE TO RELATED APPLICATIONS

This application claims priority to provisional Application No. 61/670,206, filed on Jul. 11, 2012, and to provisional Application No. 61/759,510, filed on Feb. 1, 2013. The disclosure of the prior Applications are incorporated herein by reference.

### TECHNICAL FIELD

The invention generally relates to automated systems and methods for quoting a product such as a watercraft and more specifically to an automated digital showroom management system and method.

### BACKGROUND

The cost of carrying inventory at dealerships such as, for example, a watercraft dealership (or “dealer”), is a burden to its owners due to the cost of keeping product on a showroom floor, including financing of the displayed watercraft and other overhead associated with maintaining a physical inventory. This includes the cost of the showroom space and related costs such as heating or cooling the space. Further, customers desire an increased number of available options for a watercraft and including an ability to pick and choose among options. As a result, it is nearly impossible for a dealership to maintain a physical inventory adequate to address a prospective customer's interests and requirements. Present methods of identifying desired inventory, optional content and accessories are inefficient and outdated.

Since it is impractical for a dealership to carry a full inventory it is also difficult for a dealer to properly set pricing for product lines including various options not currently in inventory. Several steps are required for the dealer to identify, categorize, and set pricing for inventory. Further, creating a watercraft by specific match, including size, options and accessories is cumbersome, utilizing manuals and calculators. Attempts to quickly respond to customers' requests and needs may result in errors in calculations. Taking more time in order to carefully use manuals and calculations risks allowing the customer to lose interest or seek competitive quotes. In addition, dealers must also hand write or type purchase agreements and finance applications. This takes time and is cumbersome. Again, delays risk losing the customer. All of these methods and information are pulled from separate sources.

Therefore, it would be desirable to provide a system and method for streamlining identification of desired inventory and accessories, as well as provide for automated and accurate preparation of pricing information, track customers including sales efforts and have automated production of important documents used in the sales effort and sale of a product such as a watercraft.

### SUMMARY OF THE INVENTION

The present disclosure addresses these needs and issues by providing a digital showroom management (DSM) system and method that provides a virtual showroom having displays of all possible options and variations of product combinations, and including accurate pricing based on a dealer's previously established parameters along with automated production of financial and sales relates documents in addition to tracking inventory and sales efforts.

It is therefore an object of the disclosure to create a virtual showroom populated with product, for example watercraft, including all variations and combinations of features and options available from the manufacturer. It is a further object of the disclosure to provide a system and method for dealers to create customized pricing, including consideration of margins, that does not need to be manually created for each customized selection of options and features by a prospective customer. It is an additional object of the disclosure to provide for automated and easy creation of finance applications, including purchase agreements, loan applications and calculations of payments. It is an additional object of the disclosure to provide these features and capabilities in an easy to use system that is portable and remotely accessible including from computer systems, laptop computers, tablets, and smart phones that a salesperson could carry with them while making a sales presentation to a prospective customer.

The present disclosure provides a quotation and inventory management system adapted to aid dealers in pricing, managing, and most importantly selling inventory without cumbersome requirements common in current applications. The system includes access by dealers to a previously created database of brands, including models, sub-models, and further including related options for each of the sub-models of a product such as watercraft. Importantly, the dealer is able to establish margins and consider its inventory costs. This system and method further provides for automated and easy generation of quote sheets, including window stickers having detail regarding the product including selected options, together with an MSRP and dealer's selling price. The system further provides for calculating financing options, taxes and further includes an ability to prepopulate purchase agreements and loan applications for the prospective customer in a quick and convenient form. Additionally, the system provides for submitting orders to a factory and, thus, maintaining an inventory of virtually unlimited scope and variation of options. The system further provides a tracking function, including quotes by salespersons and status of a customer's interest.

Other objects and features of the present invention will become apparent when viewed in light of the detailed description of the preferred embodiment when taken in conjunction with the attached drawings and appended claims.

### BRIEF DESCRIPTION OF THE DRAWINGS

The present invention will become more fully understood from the detailed description and the accompanying drawings, wherein:

FIG. 1 is a flow diagram of a setup system and method for a digital showroom manager of the invention;

FIG. 2 is a flow diagram of a dealer's access and utilization of the digital showroom manager of the invention;

FIG. 3 is a block diagram of the DSM system of the invention;

FIGS. 4-24 are diagrams of the DSM system and method including “screen shoots” of the DSM system.

### DETAILED DESCRIPTION OF THE INVENTION

In the following figures like reference numerals are used to identify identical components in the various views and embodiments. The following example is meant to be illustrative of preferred embodiments for the invention. However, those skilled in the art will recognize various additional alternative embodiments.

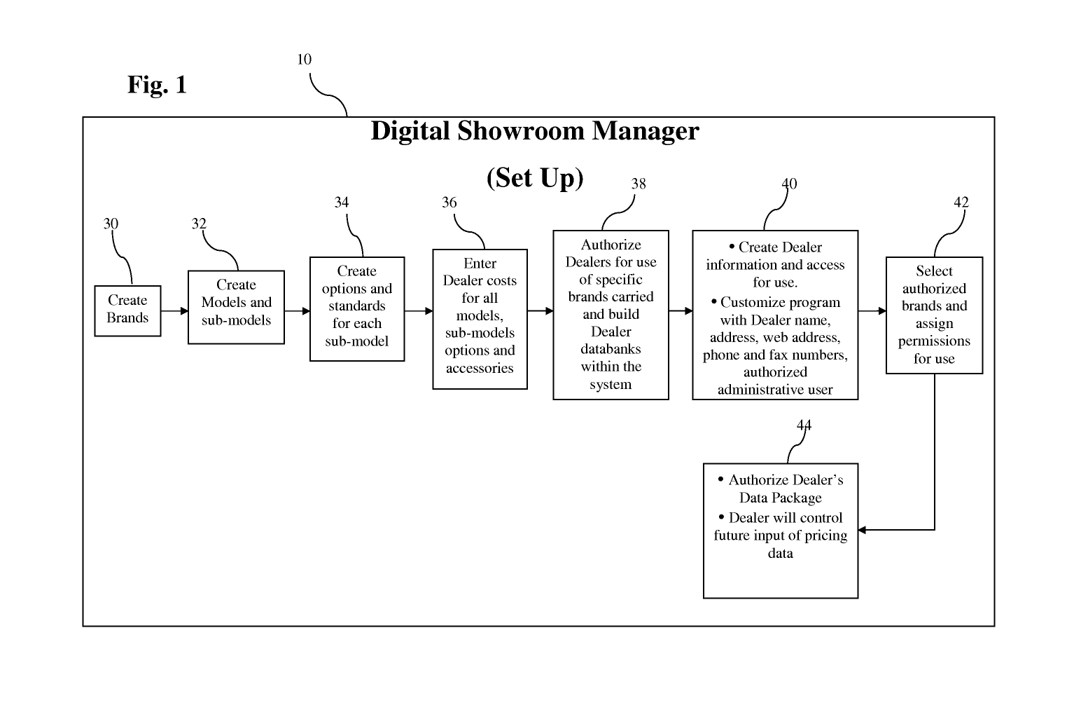

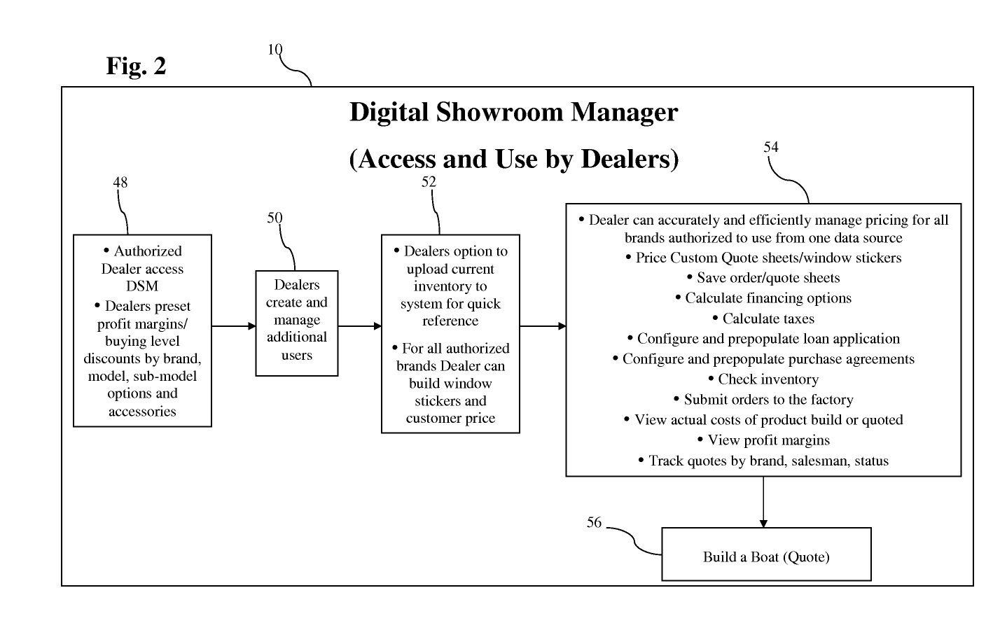

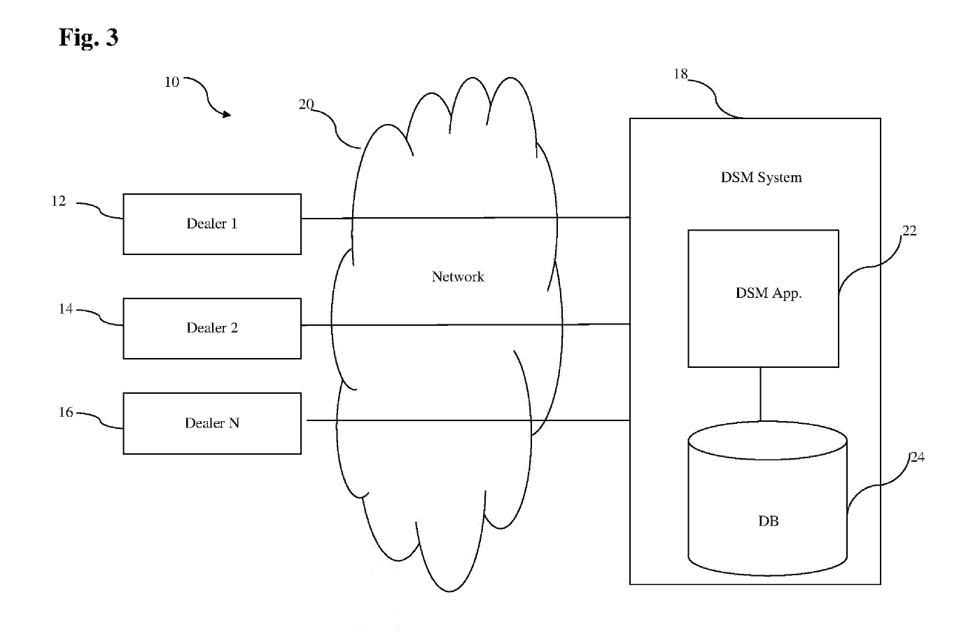

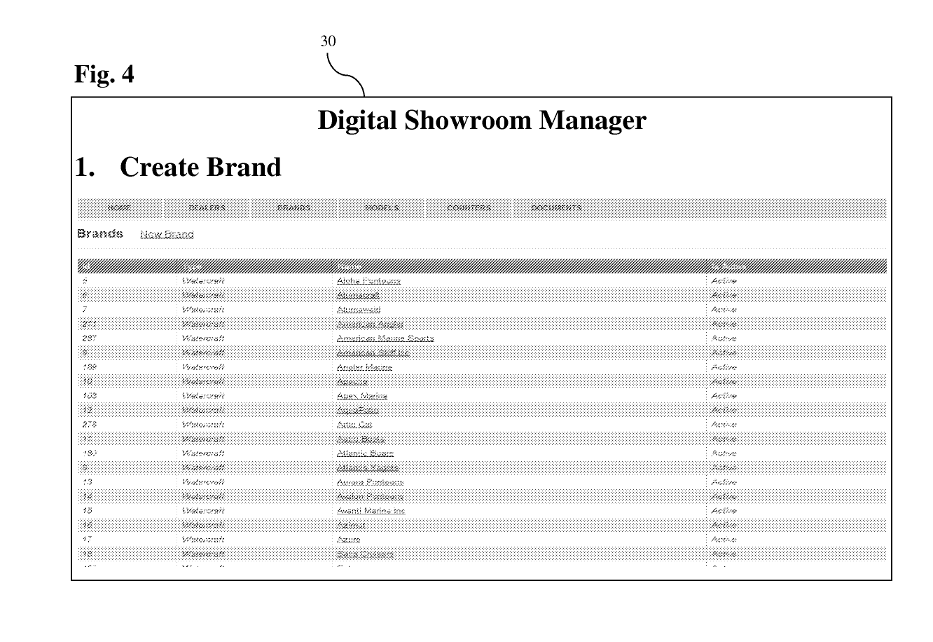

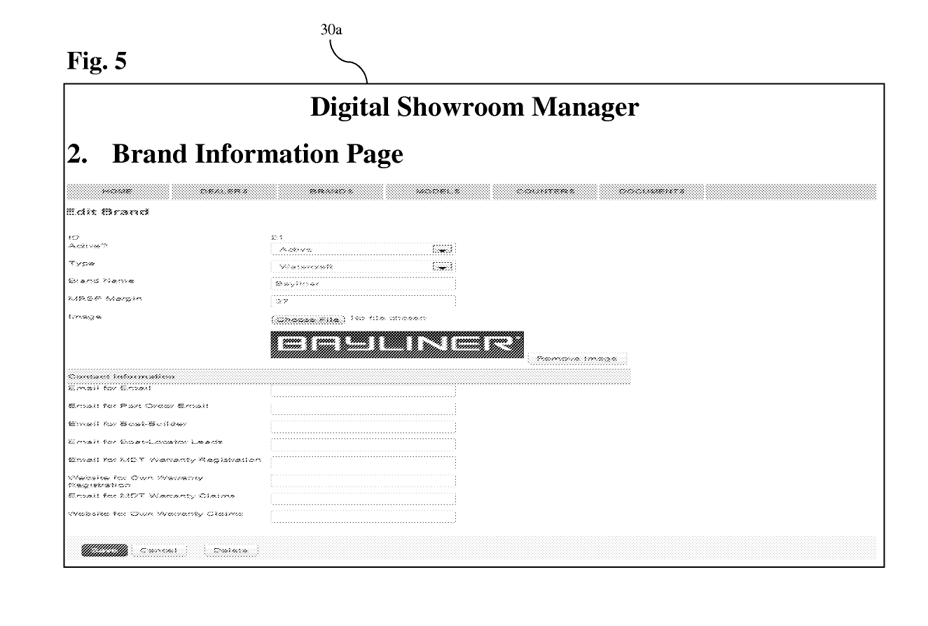

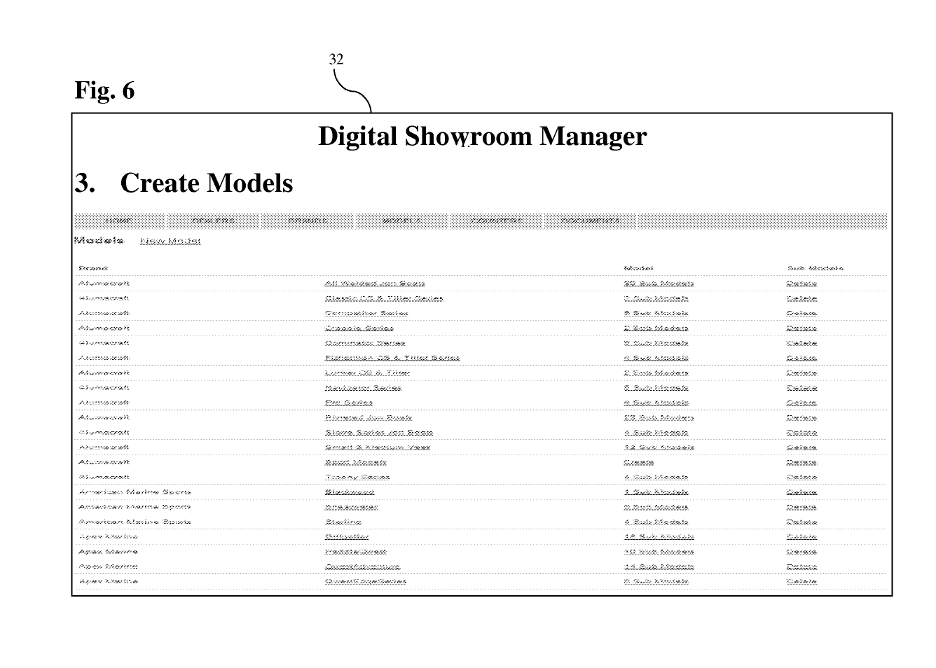

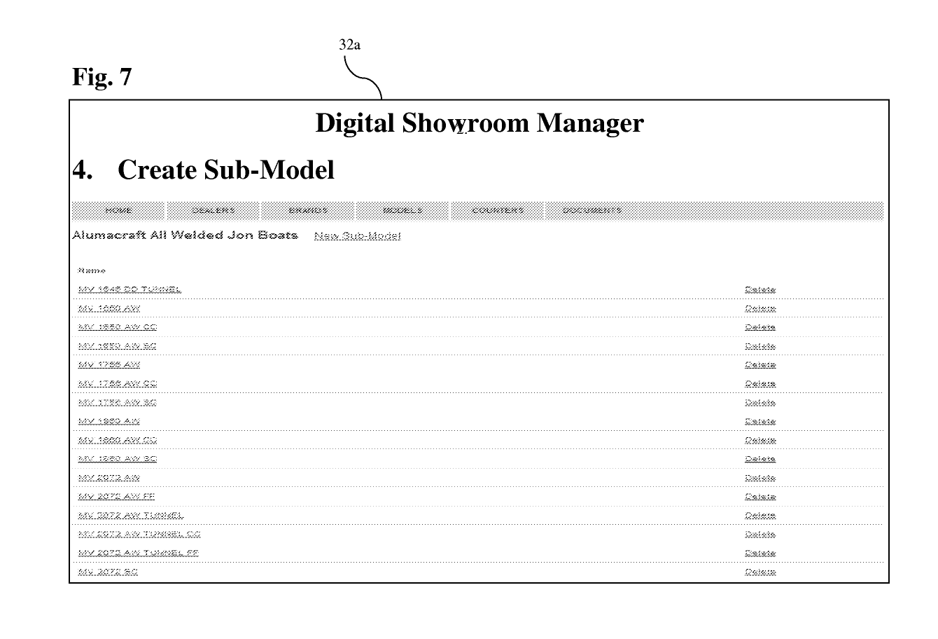

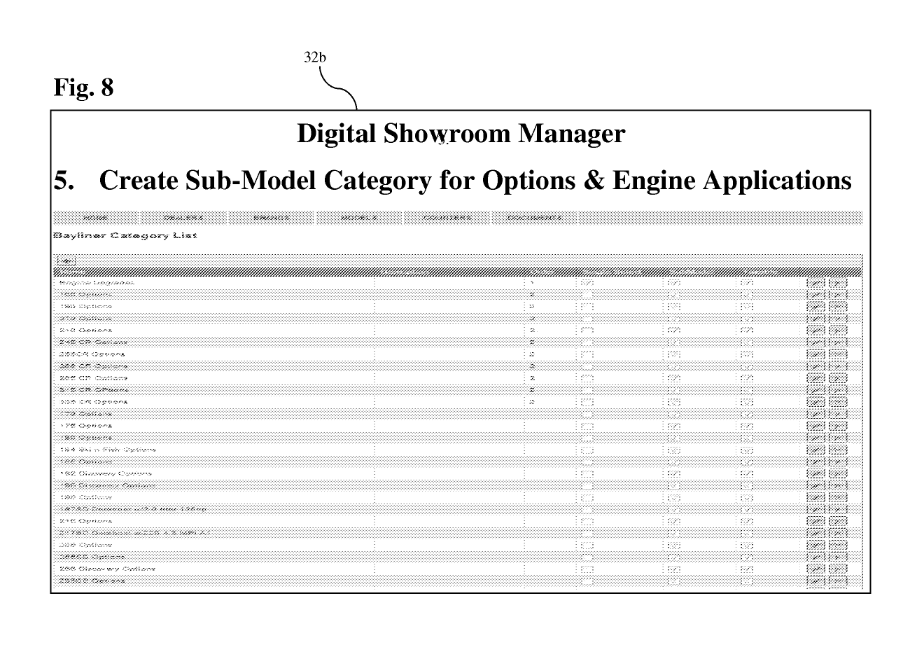

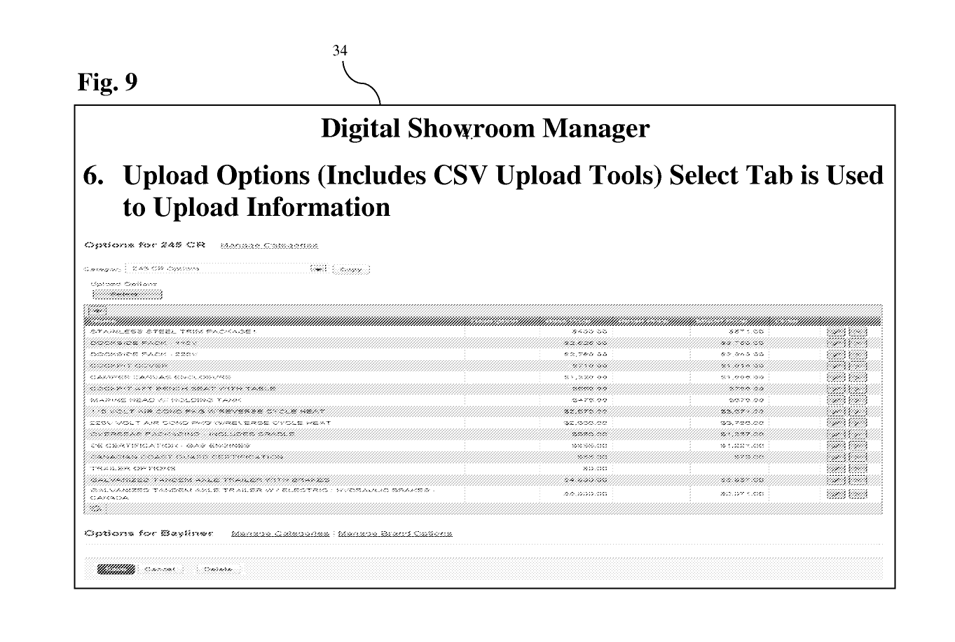

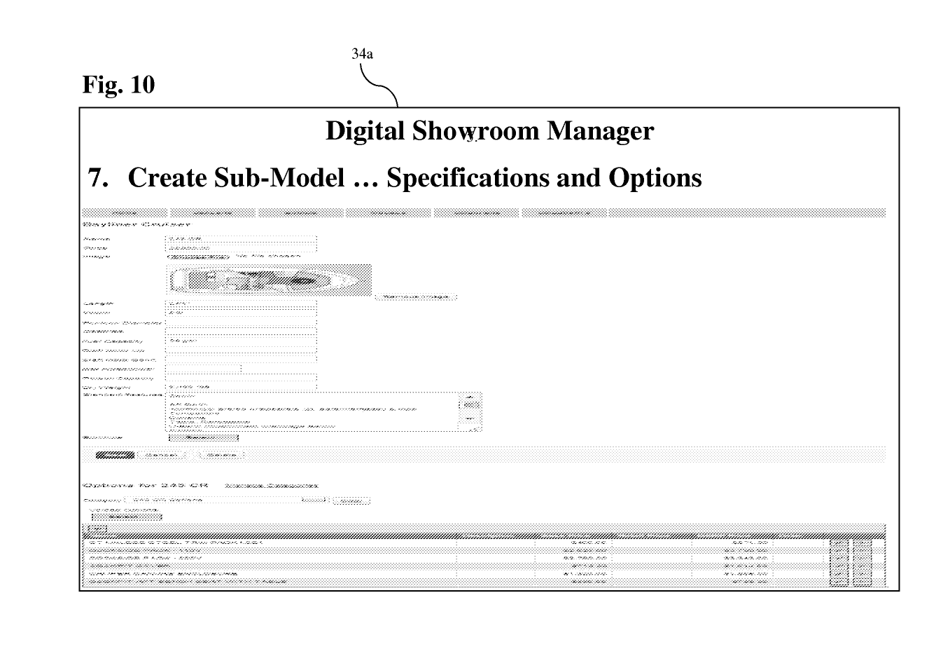

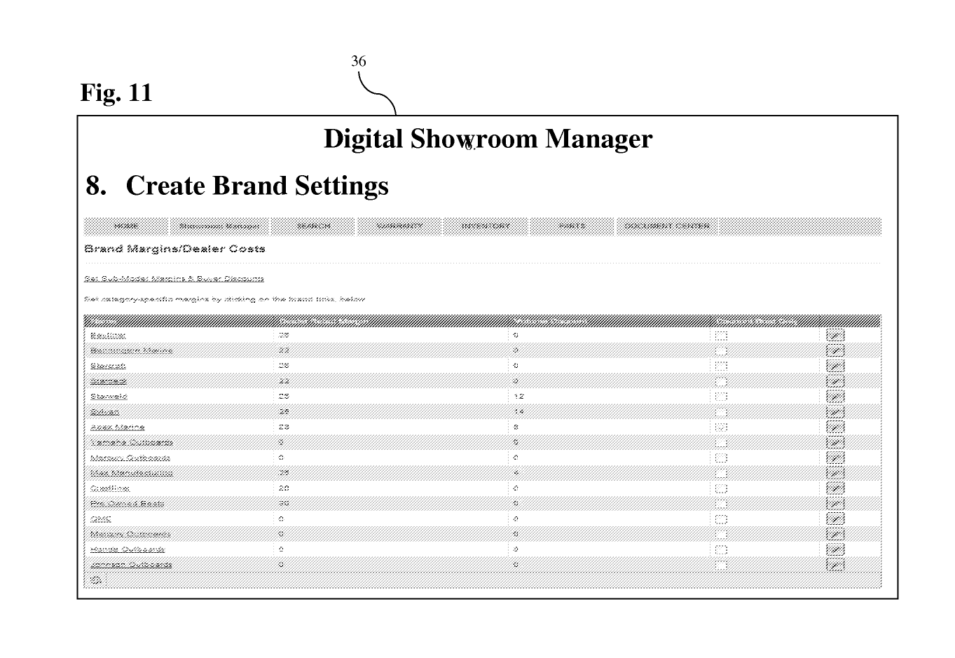

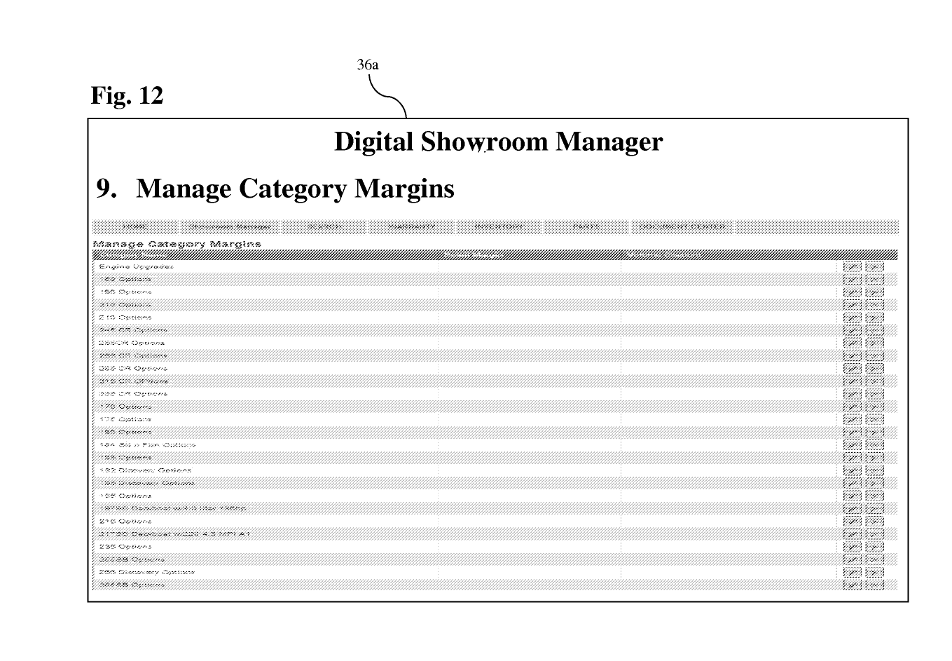

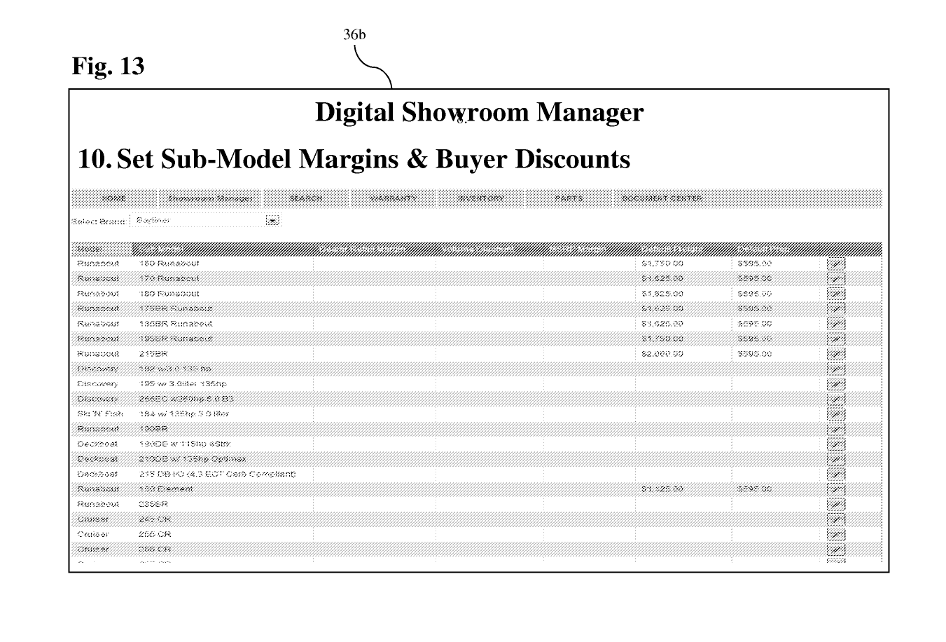

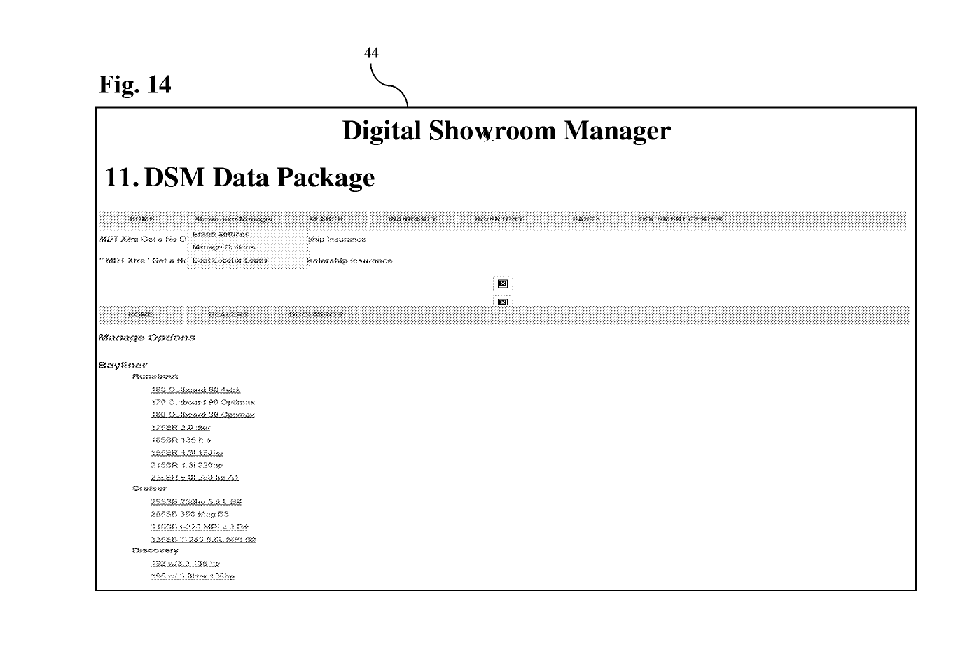

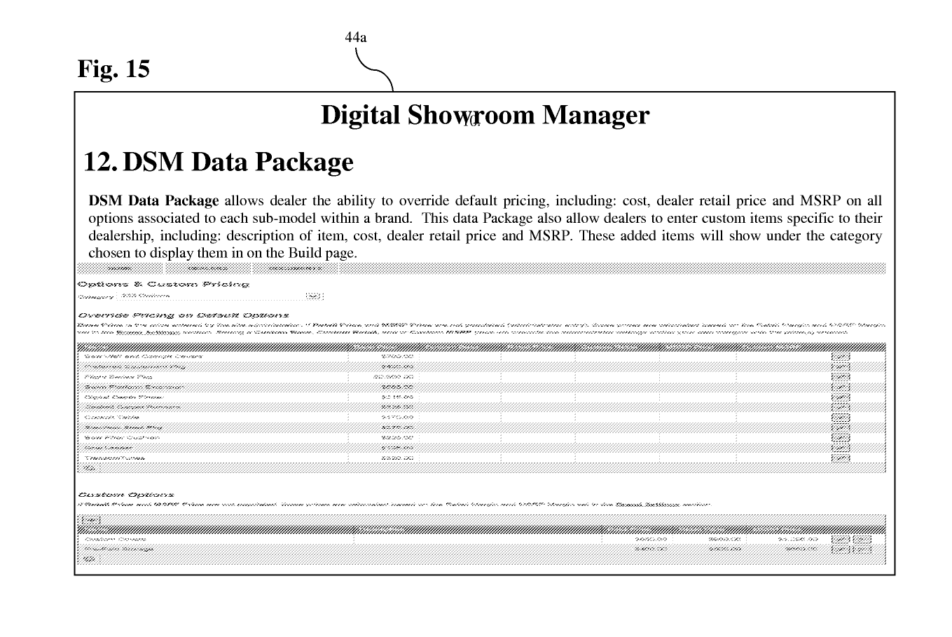

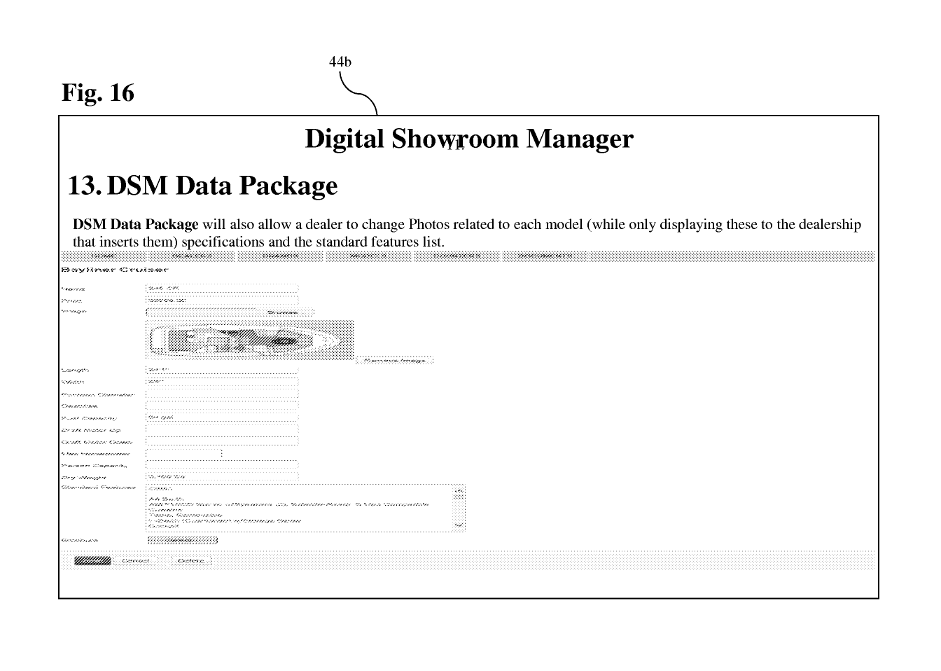

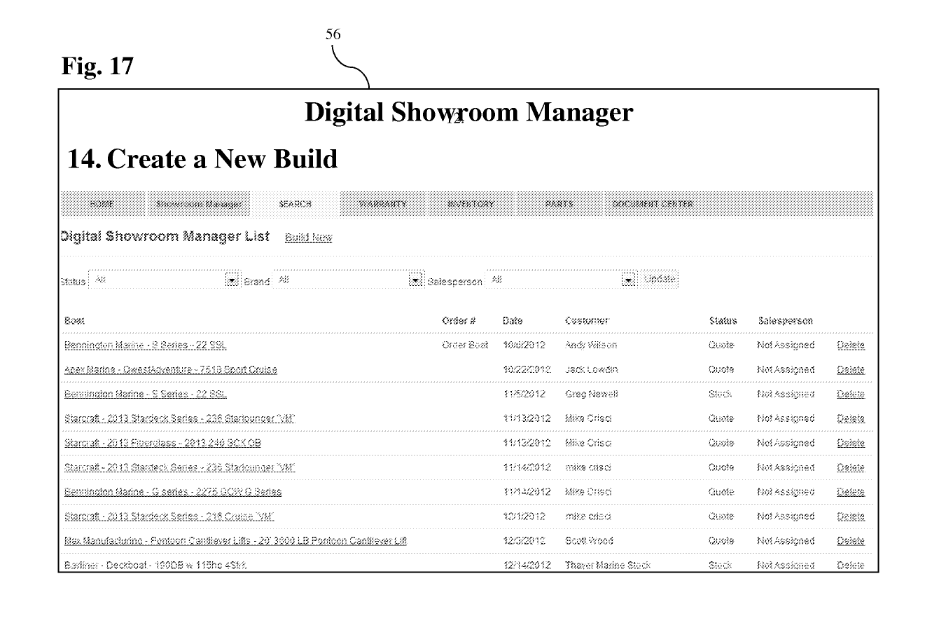

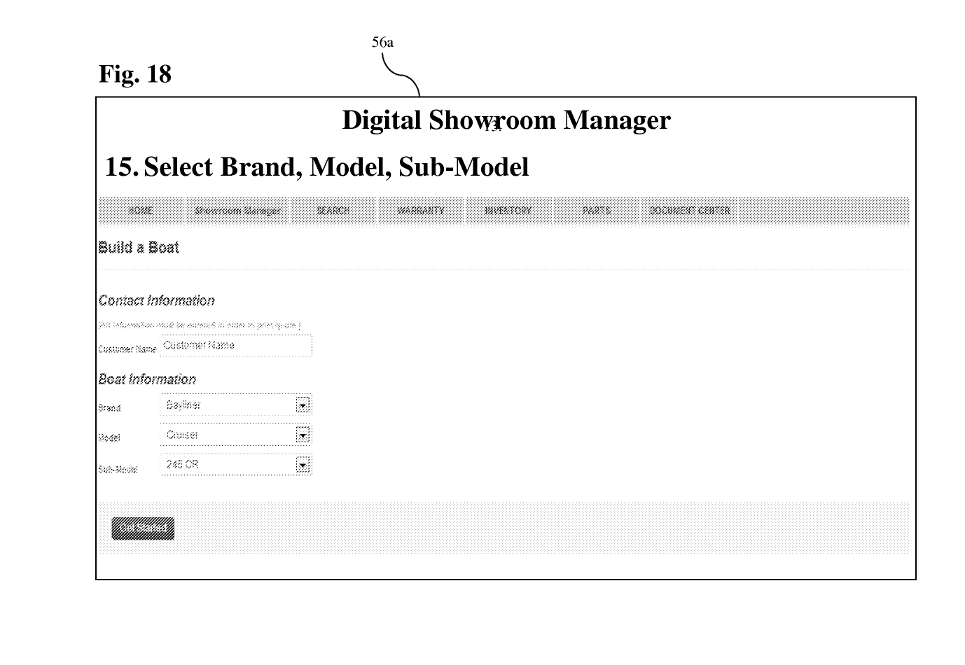

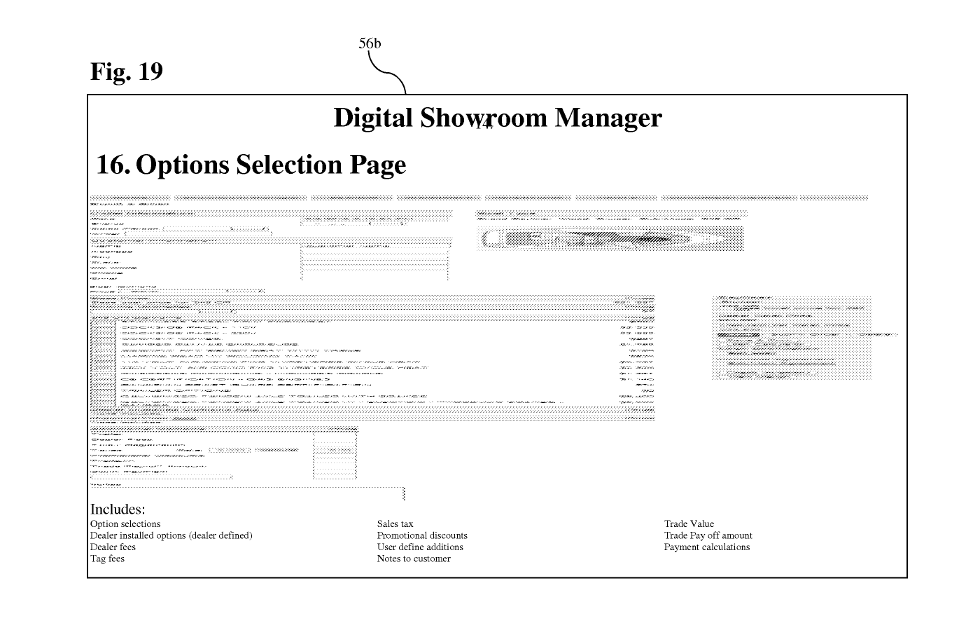

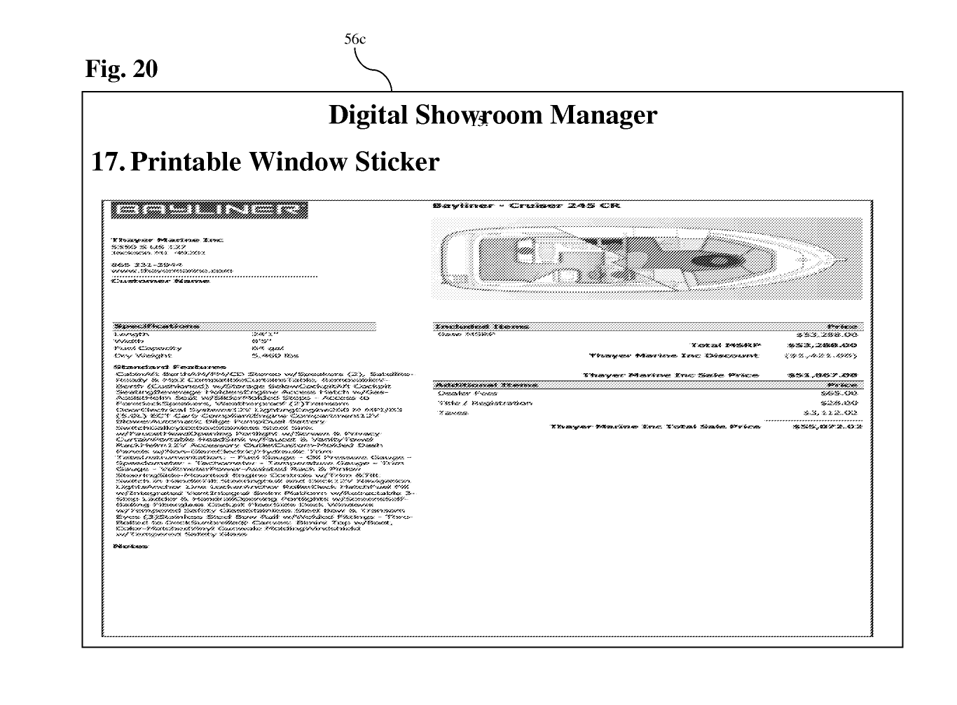

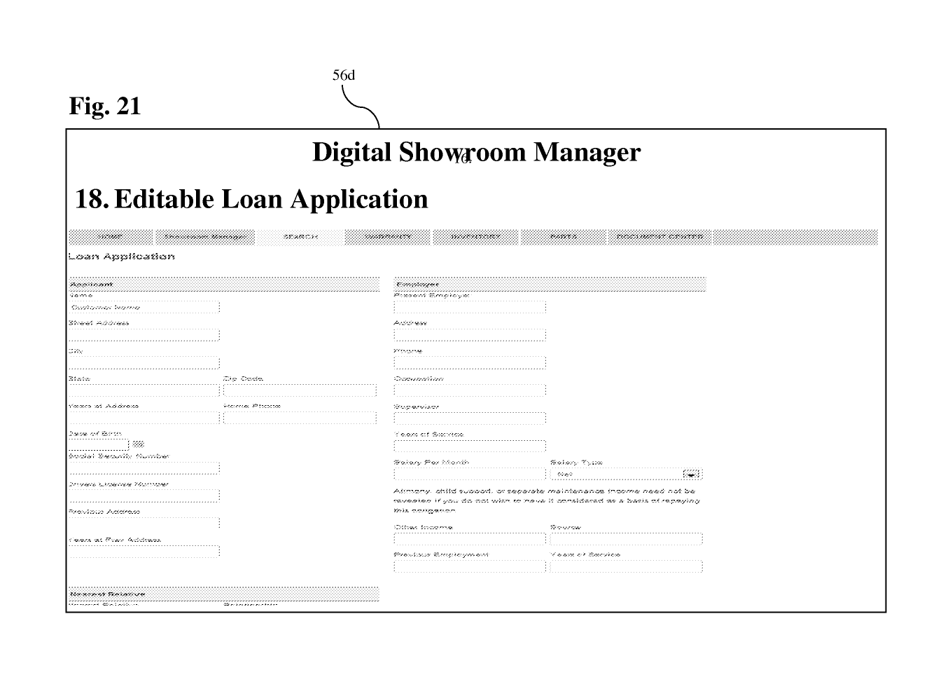

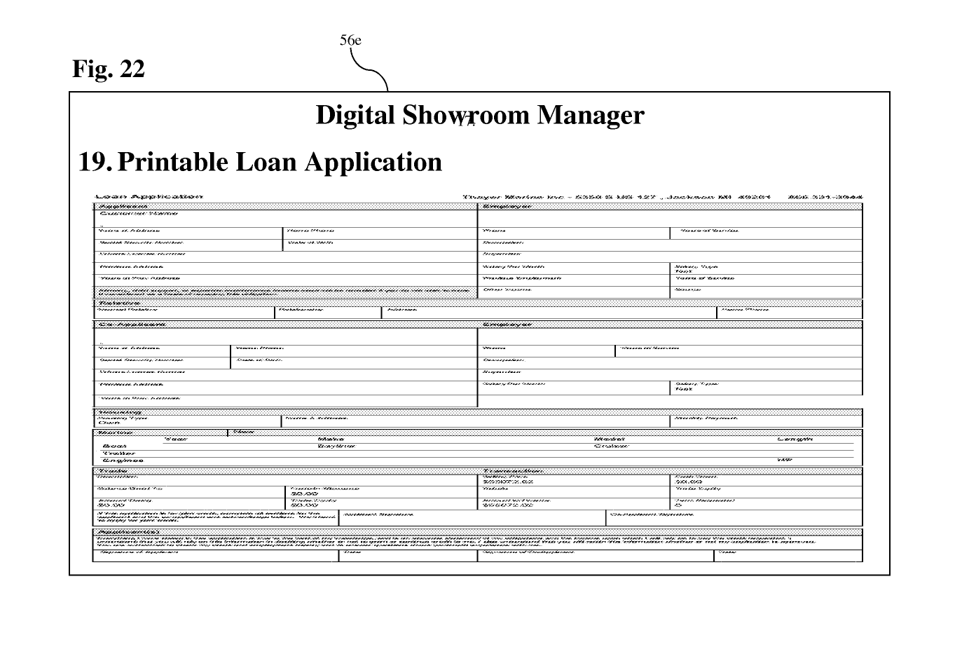

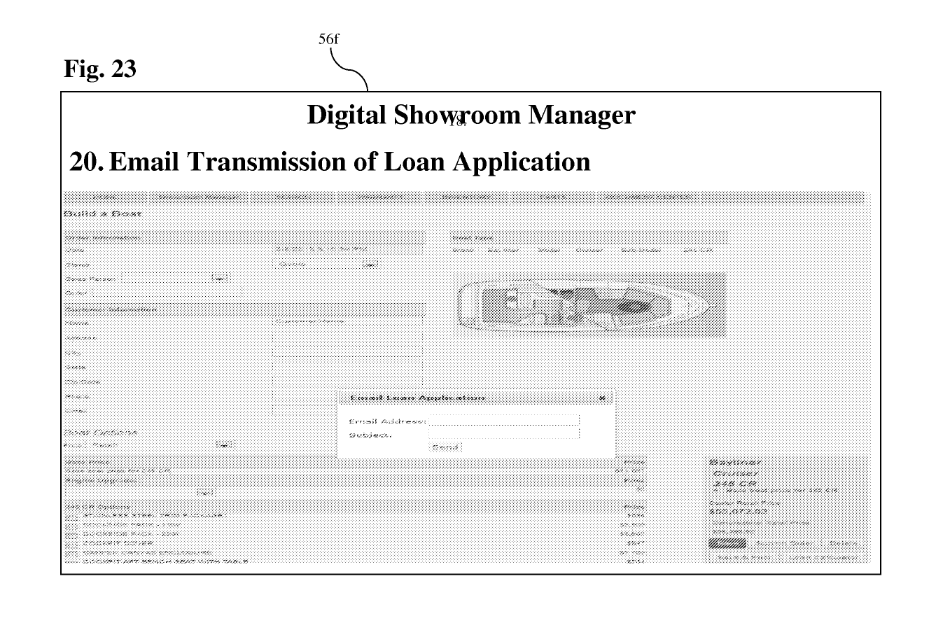

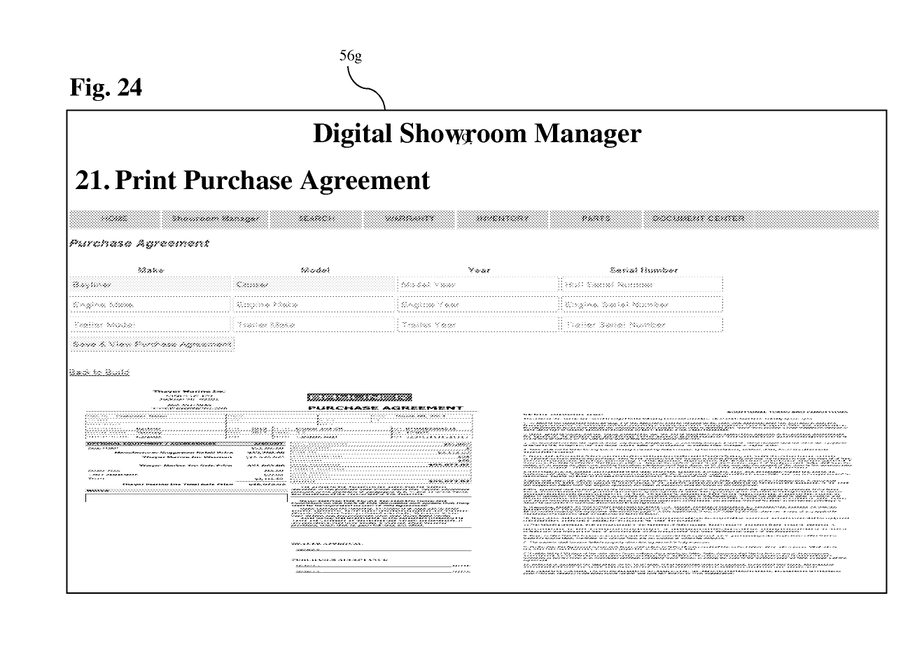

Referring to FIGS. 1-24, a digital showroom manager system and method 10 of the invention requires a computer system 18 (DSM system), including a computer database 24 and a computer network 20, for example, the internet. The DSM system 18 includes a DSM software application 22 which includes programming for both inputting and outputting data together with storing and retrieving information from the database system 24 housing data, including the data described herein. It should be appreciated that the DSM system 10 could exist as a network-based internet accessible application, including a cloud-based application and database. It should also be appreciated that the DSM software application 22 may have several application components including components existing local to a user such as on a user's computer or server. Alternatively, the DSM software application 22 may exist remotely on an internet connectable server or as a combination of local and remote components. It should also be appreciated that dealers advantageously have access to the DSM system, not only through stand-alone computers, but also through other more convenient systems that a salesperson may carry during a sales call with a prospective customer, such as laptop computers, tablet computers and even smart phones that are capable of communicating information over the network 20. It should also be appreciated that although the term “watercraft” or “boat” is repeatedly used in the description and drawings, those of skill in the art would understand that the present system and method can be practiced on any complex consumer product sales, particularly relating to products having multiple options including, but not limited to, recreational vehicles, off-road vehicles, automobiles, personal aircraft, and the like. It should also be appreciated that the DSM system and method may be used in cooperation with the method for sharing inventory disclosed in co-pending U.S. patent application Ser. No. 12/183,316, the contents of which are incorporated herein by reference. Advantageously, the DSM system and database system contains information regarding multiple brands, including multiple competing brands, but as will be explained, a dealer's access is limited to only the brands that it sells.

The DSM system and method provides for access by a plurality of dealers, including a first dealer 12, a second dealer 14, and an Nth dealer 16 representing an unknown plurality of additional dealers having access to the DSM system 18 through the network 20 including the internet and potentially a local area or other wide area networking system. Access to the DSM system 18 provides access to the DSM application 22 and its associated database system 24. The DSM system and method are administered by a system administrator.

The steps of the DSM method include creating by the system administrator entries in the DSM database 24 for a plurality of brands 30 to be sold by the dealers. A sub-step 30a includes editing brand information. Next, in step 32 the system administrator inputs detail for brand models including as a sub-step 32a the creation of sub-models. Another sub-step 32b includes inputting detail regarding sub-models including options and engine applications. Next, in step 34 the system administrator creates options and standards for each sub-model. As a sub-step 34a this also includes inputting information regarding specifications and options for a sub-model. Next, in step 36 the system administrator enters dealer costs for all models, sub-models, options and accessories. A sub-step 36a includes managing category margins. Another sub-step 36b includes setting sub-model. In the next step 38, the system administrator inputs into the system authorization detail for dealers and sets their access to specific brands. This also provides for creation of a dealer's databanks within the system. In the next step 40, the system administrator creates the dealer's information and sets access for their use. This also includes customizing for the dealer's name, address, website address, phone number, fax number and authorized administrative user at the dealer. Next, in step 42, the system administrator selects authorized brands and assigns permissions for use thus restricting the dealer to access only those brands that it carries and prevents access to other competing brands that are available within the DSM system. Next in step 44 including sub-steps 44a and 44b an optional feature includes having the system administrator authorize a dealer's data package. This includes allowing the dealer the ability to override default pricing, including costs, dealer retail price and MSRP on all options associated with each sub-model within a brand. This also allows dealers to enter a custom item specific to their dealership, including description of item, its cost, dealer retail price and MSRP. These added items will show under the category chosen to display them in the “build” page. The DSM data package will also allow a dealer to change photos related to each model (while only displaying the photos that the dealer inserts), specifications and standard features list.

Next, in step 48, an authorized dealer accesses the DSM system 18. Access is gained through the network 20 as previously disclosed. In step 48, the dealer is able to preset profit margins and buying level discounts by brand, model, sub-model, and including options and accessories. Next in step 50, the dealer creates and manages additional users such as sales persons and office managers. Next, in step 52, the dealer has the option to upload current inventory information including details regarding the dealer's inventory so that the dealer has quick reference to inventory. In addition, the dealer is able to create a window sticker and include custom pricing for each of its products in the inventory.

Next in step 54, the dealer now having been granted authorization by the system administrator, and having established and inputted its own detailed data, including specific product data and pricing/margins for the product, is now able to benefit with multiple capabilities and features offered by the DSM system 18. This includes the dealer's ability to accurately and effectively manage pricing for all authorized brands for its use from a single data source. This is a dramatic improvement over having to access and review pricing and data from multiple sources relating to multiple brands and multiple products within each brand. The dealer is also able to create custom quote sheets and window stickers, including stickers displaying certain product features and having an MSRP along with the dealer's offered sales price. Advantageously, as already indicated, this information can be created for not only existing inventory, but also for virtual inventory. Again, this provides a significant competitive advantage to a dealer being able to print a window sticker for a virtual product including a picture of the product, detail regarding its components, feature, and detail regarding pricing. Next, the dealer is able to save orders and quote sheets, thus allowing the sales force to work with a prospective customer on a continuing basis until a sale is finalized. In addition, the system provides for calculating financing options and calculating taxes on a sale. The system also advantageously will configure and prepopulate a loan application and a purchase agreement. Again, this is a significant improvement over existing systems that may require dealers to fill in forms for a particular brand and including its options. The dealer also has the ability to check its inventory that it previously input into the system. In addition, the dealer may use the system for submission of orders to the factory for manufacture of product either for its own inventory or in response to a purchase by a customer. In addition, the dealer may view its actual cost of products as built and quoted. Further, the dealer has the option of viewing and modifying its profit margins, not only on a brand basis, but on a sub-model and even option and accessory basis. Finally, the system provides ability for dealers to track quotes by brand and salesperson, and maintain a status of a sales activity.

In summary, the DSM system and method 10 provides an ability to dramatically increase sales effectiveness by offering a platform where a salesperson can meet with a customer, sit with them, discuss options, and during the discussion use a laptop, tablet or smart phone to build a boat, confidently know the associated pricing, including the dealer's intended margin, and then print out not only a window sticker for the built boat, including boats that do not exist in inventory, but also print out a loan application and purchase agreement. This is critical in a sales presentation to confront the prospective customer with options, pricing, and a pictorial representation of the product in a matter of minutes by using this automated system. There is opportunity for dramatic improvement in sales effectiveness over a salesperson meeting with a customer and then turning to books for various brands and options and features to explore pricing and tell the customer they will have to get back to them with further information at a later date.

In step 56, the dealer is advantageously able to “build” (quote) a boat (product) using the features of the system and method. This includes in step 56a selecting a boat and options. In step 56b, a printable window sticker is created. Next, in step 56c, an editable loan application may be generated. In step 56d, the loan application is printable. In step 56e, the loan application may be emailed and in step 56f, a purchase agreement may be printed. Thus, the dealer is able to quickly and effectively meet with the prospective customer, explore options for a particular brand, including accessories and features, present exact pricing for each of the features and options, and without walking away print out a window sticker for the boat, including the features, options and pricing.

In operation, the DSM system and method functions as follows:

Setting up the DSM system 18 for each brand including models, sub-models, and options, involves opening the data entry page for each model. Data is entered for each specific model and sub-model within the brands. For example, a brand of popular boat is Bayliner, a model is Bayliner Deck Boats and Bayliner 197DB is a sub-model of the brand. Once a sub-model is created, the operator enters the following information into the DSM system to create the data needed to build a boat (or RV, vehicle, aircraft, etc.).

Create sub-model for brands: [Enter name]; [Enter base dealer price]; [Enter photo, or diagram of specific model]; [Enter specifications]; [Enter standard features]; [Download brand brochure]; and [Save information].

Once the sub-model and specifications have been entered, the available options must be entered. To enter an option involves the following steps:

Enter options for sub-models: [CLICK manage categories]; [CLICK create option category list for models/boat—list of available options for each model and sub-model]; [Create the sequence of order that each option will appear on build]; [Choose if options are a single selection (only one can be selected for a quote) or if multiple options can be chosen in a category in a quote]; and [Select whether the DSM system options are taxable or not taxable—the DSM system allows for individual state taxation rates].

After the options categories are created, individual options can be imported or entered individually by entering an option name, cost (base price), or fixed retail price, MSRP, and selected order of display on a price quote page when accessed by an authorized dealer as disclosed herein. If no retail price is set, the DSM system 18 defaults to dealer settings for each brand. This allows for dealers to set options at a different profit margin than the MSRP boat price, etc.

The present method established by the digital showroom management system allows for options to be entered through an options page for each model or entry through a brand management options page icon. Once the brand management options tab has been opened, the operator chooses a category and then adds individual options and single categories, if desired. For example, engine options are numerous for boats and recreation vehicles so this category works to list numerous similar selections and prices that are under the same option. Once the operator's formatting of a brand and its models is completed as set forth above, the next step is authorizing dealer access.

Authorizing dealer access for the DSM system 18 includes using a computer algorithm in the DSM application 22 for confirming that the dealer is an authorized dealer and verifying access and allowing permission to enter data into the DSM database 24. The steps for establishing authorization for the end users (i.e., dealers) are as follows: [Authorize dealership to authorize specific brand]; [Select dealership and inventory management program]; and [Create new tab/opens icons for dealer brand page].

DSM system operator authorizes brands for dealer and enters dealer number if one applies. Verify authorization button for dealers allowing “build a boat permission” to end access to the DSM system. Once permissions are detailed, the dealer can now add users and its own permissions to allow its associates access.

DSM Dealer Set-Up by Operator

Create new: This allows electronic inventory management to enter the dealer's name into the electronic inventory management database and into the DSM database 24. Dealer information including address, contact information, phone number, email addresses, state tax rate, trade in calculations, and an ability to exclude labor from tax calculations, etc., are then inputted into the system.

Authorized brand: The DSM system 18 authorizes which brands to be accessible by the dealer and restricts access to only those brands. This provides for brand protection, which is of high importance in operation of the system. Without this protection, dealers would have access to information that could provide a competitive advantage from one brand over another when a dealer does not carry that brand. The DSM system prevents this possibility.

Users: The DSM system allows for entry of user names, email addresses, and contact information for the dealers.

Permissions: The DSM system allows for entry of and authorizes available permissions for access to the DSM system.

MSRP: It is known that different brands of boats typically have a desired percentage of profit margin as set by the manufacturer. The DSM system contains this information and reproduces it on a window sticker when a prospective customer requests a quote.

Dealerships Responsibility: Once a dealer has been granted authorized access to the DSM system, the dealer is responsible for its own management of its own DSM entered data. This includes the dealer's entry of setting for each brand that it sells including price and price structure. Advantageously, dealers have the option of maintaining their own data and pricing changes.

Dealer steps are as follows: [CLICK brand setting]. This allows access into a dealer's settings area. In this area, dealers are allowed to set the margin they desire for a profit on a particular brand and product. A dealer can enter a retail margin percent that they desire. A dealer's level of discount, if applicable, may also be entered and a check box is available for indicating if the discount applies to the boat only, and not the entire option package such as including boat, motor, options, etc. If the discounts apply to the entire package, the dealer leaves this box unchecked.

To establish retail margin, the dealer sets their desired profit margin. This information is calculated and entered on the “build” page. For example, the particular boat brand may suggest a build and profit margin of 30% in the MSRP; however, the dealer profit margin may be 20% and, further, the dealer may receive a 5% discount from the factory. The DSM system provides for tracking this information in the example as follows: $10,000 purchase with a 5% discount equals $500; dealer discount price $9,500 divided by 20% retail margin figured from dealer discount price gives dealer a retail price of $11,875. Having this information in an automated and expedited fashion provides an advantage to a salesperson working to close a deal with the customer.

Brand sub-model profit settings: Dealers have the choice to set up each brand or sub-model for each brand with the percent profit margin. This allows a dealer to set up models of various desired profit percentages. For example, Model A of a brand may be set at a 20% profit margin, and Model B for the same brand may be set at a 13% profit margin. If this is the case, the sub-model percent overrides the brand setting, so that the dealer can control margins at a sub-model level. If the dealer desires to have an exact MSRP price, the dealer can set the selling price at the same profit margin percentage. This is important if a manufacturer has a predetermined price that has been publicly advertised. Dealers may also set the retail price by entering a default MSRP price. In this instance, no percent profit margin is entered, and the sales price defaults to the dealer initiated price.

Manage users: The DSM system allows dealers to manage the users of the system by using the “manage user” icon. A dealer can add or delete users and manage access to specific parts of the DSM system.

The DSM system is used by the dealer as follows:

The dealer will login to the DSM system 18. The DSM system then prompts the dealer to enter a prospective customer's name. The dealer is next offered options to choose a brand, model within that brand, and to choose a sub-model to build.

Once this information is entered, the dealer can click the “get started” icon. This directs the dealer to a DSM system build site. After accessing the “build a boat” page of the system, the dealer may enter a status of a build, such as quote or cancel. There is a location for the dealer to enter the customer's address information, phone number, and email address. This information is then saved for future follow-up by a salesperson.

Building a price for the customer and building a window sticker for the dealership: A dealer may select from engine options for a particular boat model as requested by a customer. The dealer may then select options and accessories available for a specific boat model that they are pricing. While the dealer is selecting desired options, the DSM system is building the associated price in a price box. The price box calculates retail prices based on margin settings that the dealer entered for the particular brand and sub-models. As each option of available options is selected, the total price and option title is displayed and available for printing as a customized window sticker for the dealership to display with the product or for the customer to see. Dealers will also have the feature to manually enter an option that is not provided in this sub-model list. Dealers will also have the feature to add freight and labor charges to a build for a product. All items manually entered by the dealer will also be calculated into the total price and appear in the price box. The dealer may also enter a tax rate, trailer fees, dealer charges, title and registration fees, which will also be calculated into the price box. If a dealer desires to offer additional discounts, they may use the promotional discount area to subtract a certain amount from the price build. This will appear on the build sheet as printed. When a pricing build is complete, the dealer has several options that they may select. This includes: [save] this feature will save the build and place it in a customer list in the DSM system.

Submit order: This allows dealers to submit this product build to a participating manufacturer using the inventory database order system.

Delete: This deletes the price build.

Save and print: This saves the build in the DSM system and then creates a PDF formatted document of the actual price build into a window sticker and/or a price quote for the customer. These may be printed.

Loan calculator: Dealers may calculate a monthly payment for the customer by entering a down payment amount, interest rate, and term of the loan. If saved, the payment terms will appear on the printout.

Loan application: This is a bank application for a loan. The boat product information and customer information is automatically populated into the loan application, eliminating the need for double entry. The loan application may then be printed for faxing or emailing to a desired lender.

Purchase agreement: This creates an editable document that the dealer may use to complete the sale. All of the information for the product including the pricing is automatically loaded into the purchase agreement, thus eliminating a need for reentry.

Check inventory: The dealer may check their own inventory through the DSM system to locate specific models being built through the DSM process and determine if they are in stock or awaiting delivery.

View margin: This feature allows the dealer to check the profit margin on a potential sale. The retail price is compared to the cost of the boat being priced so that the dealer can determine sales margin.

While particular embodiments of the invention have been shown and described, numerous variations and alternative embodiments will occur to those skilled in the art. Accordingly, it is intended that the invention be limited only in terms of the appended claims.

What is claimed is:

1. A computer implemented method for establishing and managing a digital showroom, comprising:
providing a digital management showroom system including a software application using computer database system adapted for storing data for a plurality of brands of a product line wherein the plurality of brands comprises competing brands;
inputting data into the database by a system administrator including detail about the plurality of brands including branding information, product information for the brand, options available for a particular product, and pricing information for the brands, products and options;
qualifying by the system administrator a plurality of dealers to use the digital management showroom system;
limiting access of the qualified dealers to brand information of the brands being sold by each of the dealers;
the qualified dealers inputting into the database system detail about their margin rates for the brands being sold; and
providing the qualified dealers an ability to print pricing information for a particular product including MSRP pricing, dealer discount pricing and options selected for the product.

2. The computer implemented method for establishing and managing a digital showroom of claim 1, further comprising:
the dealer inputting data into the database system including margin information for options for the product.
